(19) United States
(12) Patent Application Publication
(10) Pub. No.: US 2013/0020517 A1
(43) Pub. Date: Jan. 24, 2013

(54) COUPLER

(71) Applicant: Takahiro Sugiura, Shizuoka (JP)

(72) Inventor: Takahiro Sugiura, Shizuoka (JP)

(73) Assignee: ASAHI DENSO CO., LTD., Shizuoka (JP)

(21) Appl. No.: 13/437,328

(22) Filed: Apr. 2, 2012

(30) Foreign Application Priority Data
Jul. 21, 2011 (JP) 2011-160084

(51) Int. Cl. F16L 37/30

(52) U.S. Cl. 251/149.1

(57) ABSTRACT

A coupler includes a first connector and a second connector. The first connector includes a first connector main body and the first connector valve member. The second connector includes a second connector main body and a second connector valve member. A part of the first connector valve member is to be inserted in an insertion portion of the second connector and a seal between an outer circumference of the first connector valve member and an inner circumference of insertion portion of the second connector is formed by a seal on the first connector valve member. An axial length from a leading end of the second connector main body to a leading end of the second connector valve member is larger than an axial length from a leading end of the first connector valve member to the seal.

### BACKGROUND OF THE INVENTION

1. Field of the Invention

The invention relates to a coupler.

2. Related Art

An outboard motor attached to a small ship generally has a fuel inlet that introduces fuel and supplies the fuel to an engine. By connecting an end of a fuel tube extending from a fuel tank to the fuel inlet, the fuel in the fuel tank is supplied to the outboard motor. The fuel tank has a fuel outlet and a connector is formed at the other end of the fuel tube (opposite to the end connected to the fuel inlet) to be connected to the fuel outlet.

Connectors including sealing members are formed at the ends of the fuel tube and the fuel inlet or the fuel outlet, respectively. By coupling these connectors to each other, the end of the fuel tube is connected to the fuel inlet or the fuel outlet. Thereby, a coupler for the fuel tube is configured by these connectors.

According to the above coupler, if an inside of the outboard motor or the fuel tank is under high pressure, the fuel may spurt when the connector formed at the end of the fuel tube is connected to the fuel inlet or the fuel outlet or when the connector is disconnected from the fuel inlet or the fuel outlet. That is, when the connectors are coupled to each other, sealing by the sealing member in each of the both connector is released. Thus, if the fuel is under high pressure, the fuel may spurt when the connector are coupled to each other or disconnected from each other.

### SUMMARY OF THE INVENTION

One or more embodiments provide a coupler which can prevent fluid from spurting when connectors are coupled to each other or disconnected from each other.

### BRIEF DESCRIPTION OF THE DRAWINGS

FIG. 1 is a view illustrating a whole configuration including a coupler according to a first embodiment.

FIG. 2 is top, side, and front views illustrating a first connector of the coupler.

FIG. 3 is a cross sectional view taken along line of FIG. 2.

FIG. 4 is top, side, and front views illustrating a second connector (on an outboard motor) of the coupler.

FIG. 5 is a cross sectional view taken along line V-V of FIG. 4.

FIG. 6 is a cross sectional view illustrating a connecting process (a state before coupling) between the first connector and the second connector of the coupler.

FIG. 7 is a cross sectional view illustrating a connecting process (an insertion state) between the first connector and the second connector of the coupler.

FIG. 8 is a cross sectional view illustrating a connecting process (an operation start state) between the first connector and the second connector of the coupler.

FIG. 9 is a cross sectional view illustrating a connecting process (a state after operation) between the first connector and the second connector of the coupler.

FIG. 10 is a side view illustrating a coupling state between the first connector and the second connector of the coupler.

FIG. 11 is top, side, and front views illustrating a second connector (on a fuel tank) of the coupler.

FIG. 12 is a cross sectional view taken along line XII-XII of FIG. 11.

FIG. 13 is a cross sectional view illustrating a connecting process (a state before connecting) between the first connector and the second connector of the coupler.

FIG. 14 is a cross sectional view illustrating a connecting process (an insertion state) between the first connector and the second connector of the coupler.

FIG. 15 is a cross sectional view illustrating a connecting process (an operation start state) between the first connector and the second connector of the coupler.

FIG. 16 is a cross sectional view illustrating a connecting process (a state after operation) between the first connector and the second connector of the coupler.

FIG. 17 is a side view illustrating a coupling state between the first connector and the second connector of the coupler.

FIG. 18 is top, side, and front views illustrating a first connector of a coupler according to a second embodiment of the present invention.

FIG. 19 is a cross sectional view taken long line XIX-XIX of FIG. 18.

FIG. 20 is top, side, and front views illustrating a second connector (on an outboard motor) of the coupler.

FIG. 21 is a cross sectional view taken along line XXI-XXI of FIG. 20.

FIG. 22 is a cross sectional view illustrating a connecting process (an insertion state) between the first connector and the second connector of the coupler.

FIG. 23 is a cross sectional view illustrating a connecting process (an operation start state) between the first connector and the second connector of the coupler.

FIG. 24 is a cross sectional view illustrating a connecting process (a state after operation) between the first connector and the second connector of the coupler.

### DETAILED DESCRIPTION OF THE EMBODIMENTS

Hereinafter, the embodiments of the present invention will be described in detail with reference to the accompanying drawings. The embodiments described herein are not intended to limit the invention but only to exemplify the invention, and all features or combinations of the features of the embodiments are not always essential to the invention.

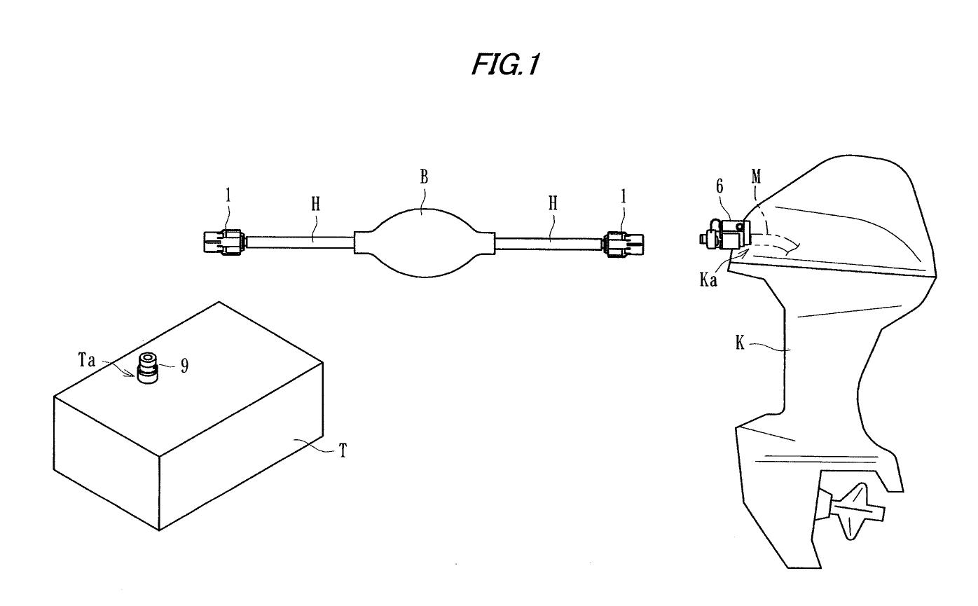

As shown in FIG. 1, a coupler according to a first embodiment connects an end of a fuel tube H to a fuel inlet Ka of an outboard motor K or a fuel outlet Ta of a fuel tank T. The coupler may include a first connector 1, a second connector 6 that is attached to the fuel inlet Ka of the outboard motor K, and another second connector 9 that is attached to the fuel outlet Ta of the fuel tank T. A sign ‘B’ in FIG. 1 indicates a primary valve that is connected to a middle portion of the fuel tube H.

The outboard motor K corresponds to a driving source of a boarding means (e.g. a small ship) according to an embodiment. The outboard motor K includes an engine that is driven by supplied fuel and a screw that is rotated by driving of the engine, thereby gaining momentum of the small ship. The fuel tube H is made of a flexible tubular element that can allow fuel to flow, and has a size so that the fuel tube H can extend from the fuel tank T mounted on a predetermined position of the small ship to the outboard motor K.

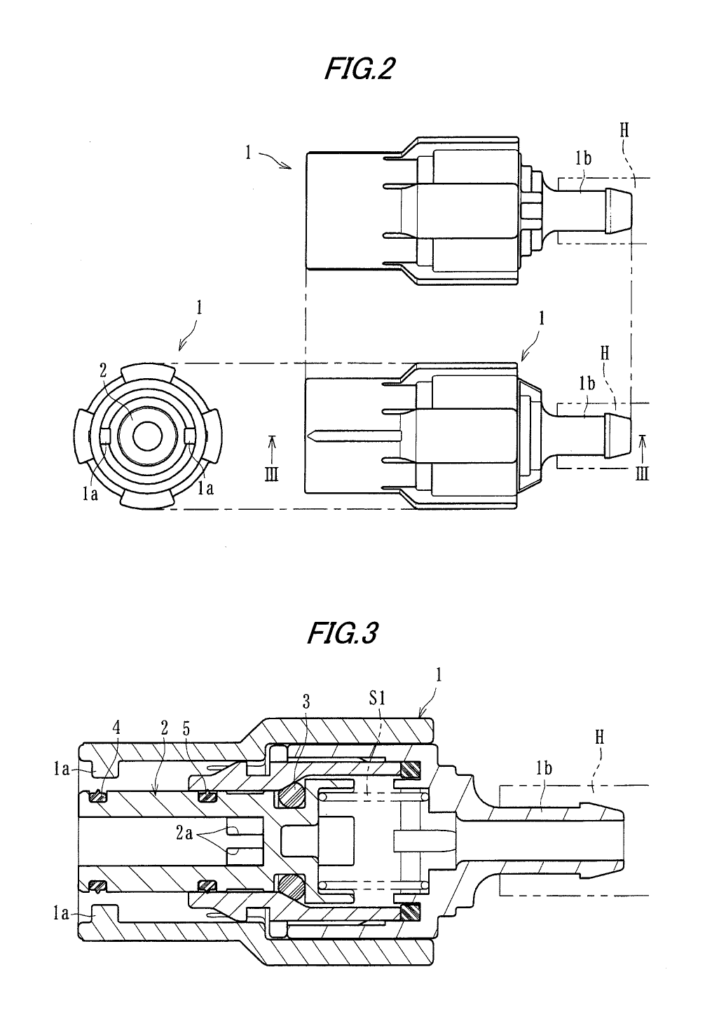

The first connector 1 is formed at one end of the fuel tube H (a right end of FIG. 1), and includes a pair of engaging portions 1a, a connecting portion 1b to which the fuel tube H is connected, a valve member 2, a first sealing member 3, and a third sealing member (a non-fuel-tube-side-sealing-member 4 and a fuel-tube-side-sealing-member 5), as shown in FIGS. 2 and 3. Among these, the engaging portions la are formed in an inwardly protruding shape and may be fitted into a recess 6a, 9a formed on the second connector 6, 9.

The valve member 2 is received in the first connector 1 and is slidable in an axis direction (in a horizontal direction of FIG. 3), and includes the first sealing member 3 that closes and seals the end of the fuel tube H. The valve member 2 is always o urged by a spring S1 in a direction of pressing the first sealing member 3 to a wall surface (a leftward direction in FIG. 3), and sealing is achieved by the first sealing member 3 under such a urging force and a channel at the end of the fuel tube H is closed and sealed. The first sealing member 3 may be an O-ring that can seal a channel of fuel.

The valve member 2 includes a first communication hole 2a that fluidly communicates with an inside and an outside thereof, and allows the fuel to flow from the connecting portion 1b through the first communication hole 2a when the sealing by the first sealing member 3 is released (specifically, when the sealing is released by connecting the first connector 1 and the second connector 6 to each other). The third sealing member (the non-fuel-tube-side-sealing-member 4 and the fuel-tube-side-sealing-member 5) are attached to an outer circumference of the valve member 2. Like the first sealing member 3, the non-fuel-tube-side-sealing-member 4 and the fuel-tube-side-sealing-member 5, which serve as the third sealing member, may be an O-ring that can seal a channel of fuel.

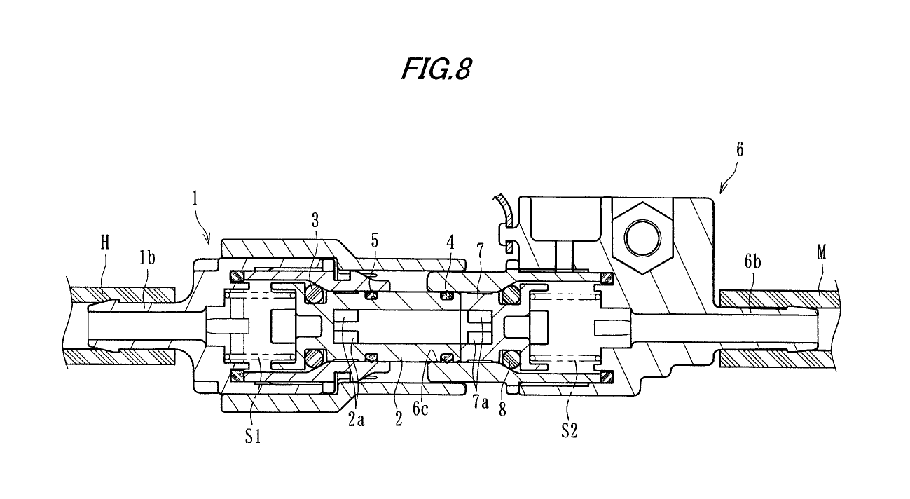

The fuel-tube-side-sealing-member 5 forms a sealed space by sealing a space including the first communication hole 2a with the first sealing member 3 in a state in which the sealing by the first sealing member 3 is maintained in the process of connecting the first connector 1 and the second connector 6 to each other. The non-fuel-tube-side-sealing-member 4 forms a sealed space by sealing a space including a second communication hole 7a with a second sealing member 8 in a state in which sealing by the second sealing member 8 (see FIG. 5) is maintained in the process of connecting the first connector 1 and the second connector 6 to each other (see FIG. 8).

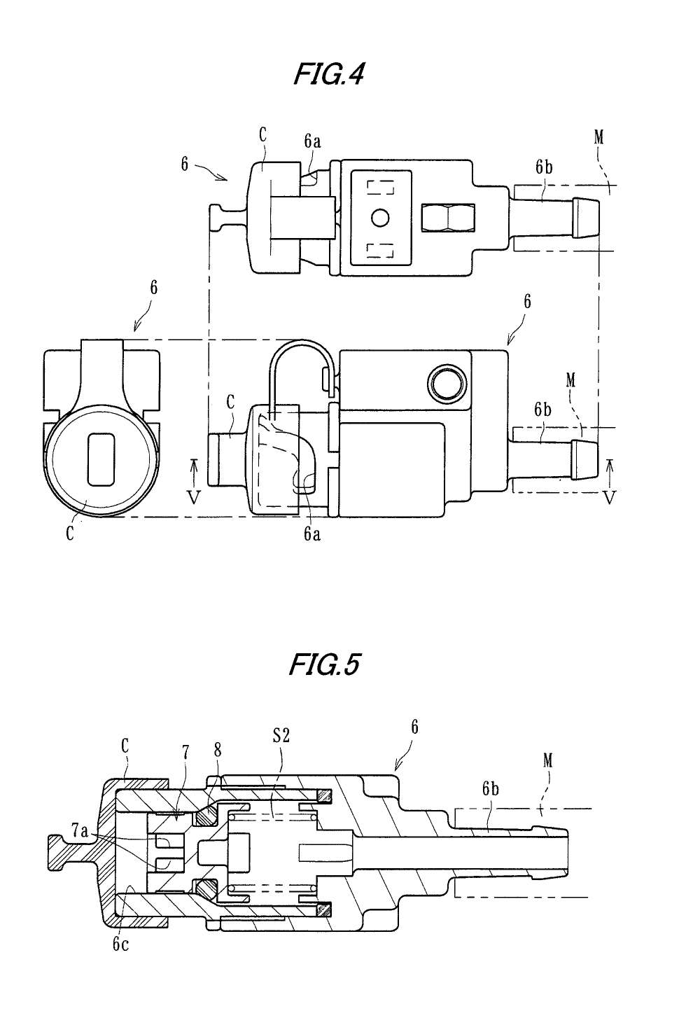

The second connector 6 is formed at the fuel inlet Ka of the outboard motor K and is connectable to the first connector 1. As shown in FIGS. 4 and 5, the second connector 6 includes a pair of recesses 6a, a connection portion 6b that is connected to a fuel tube M extending to an engine (not shown) of the outboard motor K, an insertion portion 6c into which the valve member 2 of the first connector 1 is inserted, a valve member 7, and the second sealing member 8. Among these, the recesses 6a are engaged with the engaging portions 1a when the first connector 1 and the second connector 6 are coupled to each other, thereby locking the coupling state.

The valve member 7 is received in the second connector 6 and is slidable in an axis direction (in a horizontal direction of FIG. 5), and includes the second sealing member 8 that closes and seals the fuel inlet Ka of the outboard motor K. The valve member 7 is always urged by a spring S2 in a direction of pressing the second sealing member 8 to a wall surface (in a leftward direction in FIG. 5), and sealing is achieved by the second sealing member 8 under such a urging force and a channel at the fuel inlet Ka is closed and sealed. The second sealing member 8 may be an O-ring that can seal a channel of fuel.

The valve member 7 includes the second communication hole 7a that fluidly communicates with an inside and an outside thereof, and allows the fuel to flow to the connection portion 6b through the second communication hole 7a when the sealing by the second sealing member 8 is released (specifically, when the sealing is released by connecting the first connector 1 and the second connector 6 to each other). A sign C in FIG. 5 indicates a cap that closes the insertion portion 6c of the second connector 6, and the cap C is opened to facilitate the connection with the first connector 1.

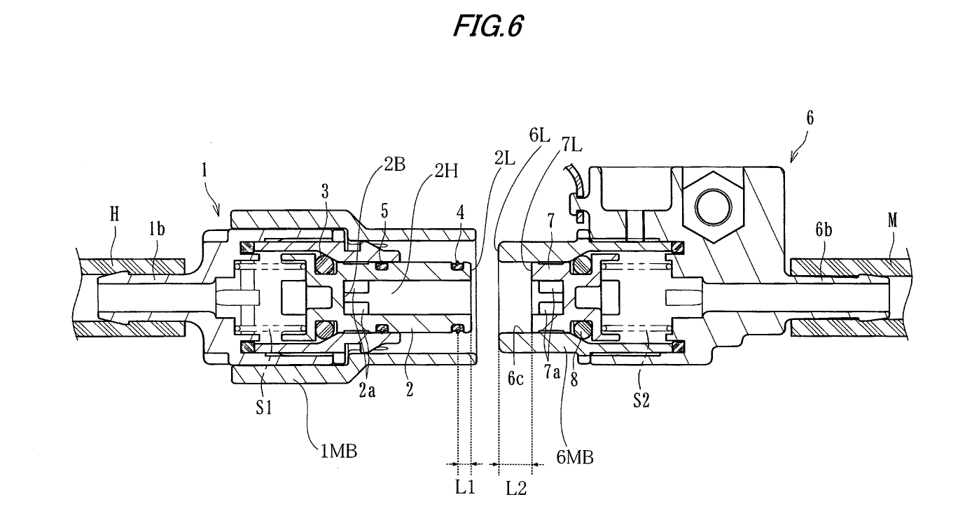

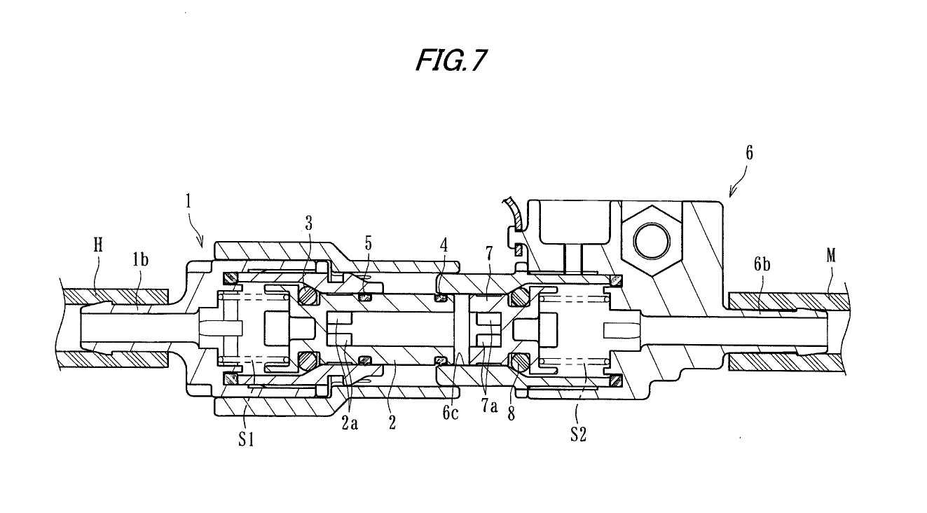

Hereinafter, an operation in the process of connecting the first connector 1 and the second connector 6 to each other will be explained. After the end of the fuel tube H is extended to the outboard motor K, the first connector 1 approaches the second connector 6 opposite to the second connector 6 as shown in FIG. 6. If the approaching operation continues after an end of the valve member 2 of the first connector 1 is inserted into the insertion portion 6c of the second connector 6 as shown in FIG. 7, the end of the valve member 2 contacts an end of the valve member 7 of the second connector 6 as shown in FIG. 8.

In this state, the first sealing member 3 of the first connector 1 maintains the sealing and the fuel-tube-side-sealing-member 5 forms the sealed space by sealing the space including the first communication hole 2a with the first sealing member 3. Likewise, the second sealing member 8 of the second connector 6 maintains the sealing and the non-fuel-tube-side-sealing-member 4 forms the sealed space by sealing the space including the second communication hole 7a with the second sealing member 8.

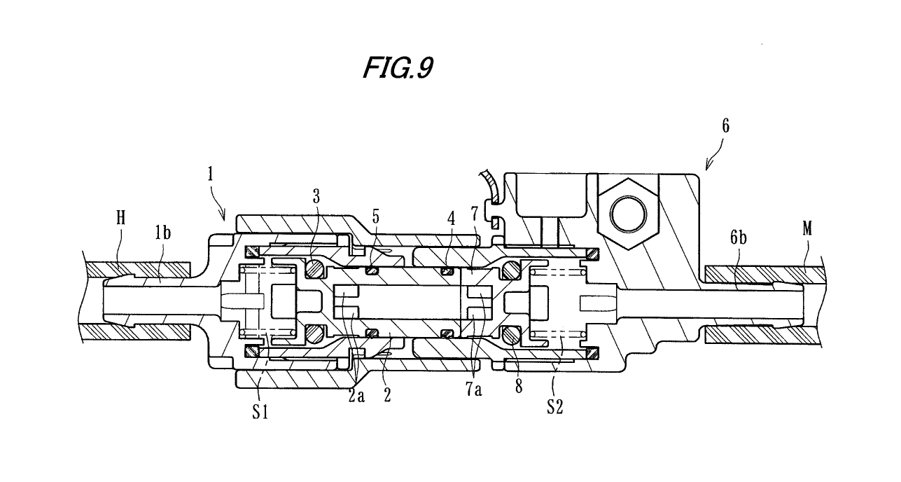

After that, if the approaching operation further continues, the valve member 2 is moved against the urging force of the spring S1 and the first sealing member 3 is separated from the wall surface so that the sealing by the first sealing member 3 is released, and, the valve member 7 is moved against the urging force of the spring S2 and the second sealing member 8 is separated from the wall surface so that the sealing by the second sealing member 8 is released, as shown in FIG. 9. After sealing is achieved by the third sealing member (the fuel-tube-side-sealing-member 5 and the non-fuel-tube-side-sealing-member 4), the sealing by the first sealing member 3 and the sealing by the second sealing member 8 are released.

That is, after the sealing is achieved by the fuel-tube-side-sealing-member 5 and the non-fuel-tube-side-sealing-member 4, the sealing by the first sealing member 3 and the sealing by the second sealing member 8 are simultaneously released. Accordingly, the fuel flowing through the fuel tube H reaches the connection portion 6b of the second connector 6 through the first communication hole 2a of the first connector 1 and the second communication hole 7a of the second connector 6, and is supplied to the engine of the outboard motor K through the fuel tube M

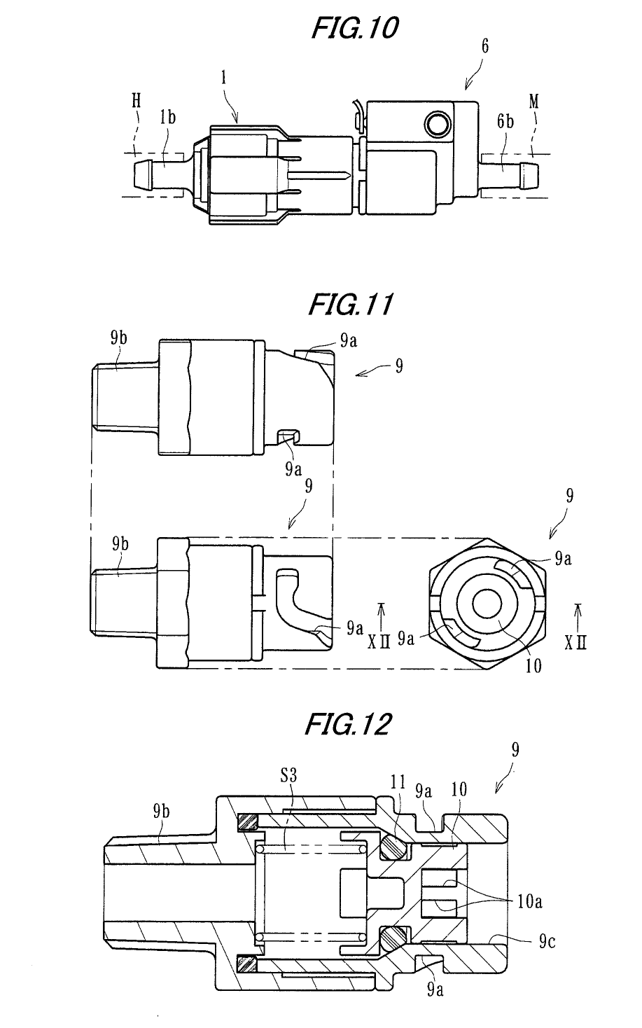

According to the exemplary embodiment, in the process of connecting the first connector 1 and the second connector 6 to each other, the engaging portions 1a are fitted into the recesses 6a and slide along the recesses 6a. After the connection, locking is achieved by rotating the first connector 1 on the second connector 6 (see FIG. 10). That is, the engaging portions 1a and the recesses 6a configure a locking mechanism that locks the coupling state between the first connector 1 and the second connector 6, and the locking is achieved by rotating the connector 1 on the second connector 6.

In order to release the connection and disconnect the first connector 1 and the second connector 6 from each other, the locking by the engaging portions 1a and the recesses 6a (the locking mechanism) is released by rotating the first connector 1 on the second connector 6 in an opposite direction to the direction of the locking. After the sealing is achieved by the first sealing member 3 and the second sealing member 8 and the sealed space is formed with the third sealing member (the fuel-tube-side-sealing-member 5 and the non-fuel-tube-side-sealing-member 4) by separating the first connector 1 from the second connector 6, the first connector 1 and the second connector 6 are disconnected from each other.

Specifically, in the process of disconnecting the first connector 1 and the second connector 6 from each other, the valve member 2 and the valve member 7 are moved in an opposite direction to that of the connection and the first sealing member 3 and the second sealing member 8 contact the wall surface, thereby achieving the sealing. After the sealing by the first sealing member 3 and the sealing by the second sealing member 8 are achieved simultaneously and the sealed spaces are formed with the fuel-tube-side-sealing-member 5 and the non-fuel-tube-side-sealing-member 4 simultaneously, the first connector 1 and the second connector 6 are disconnected from each other.

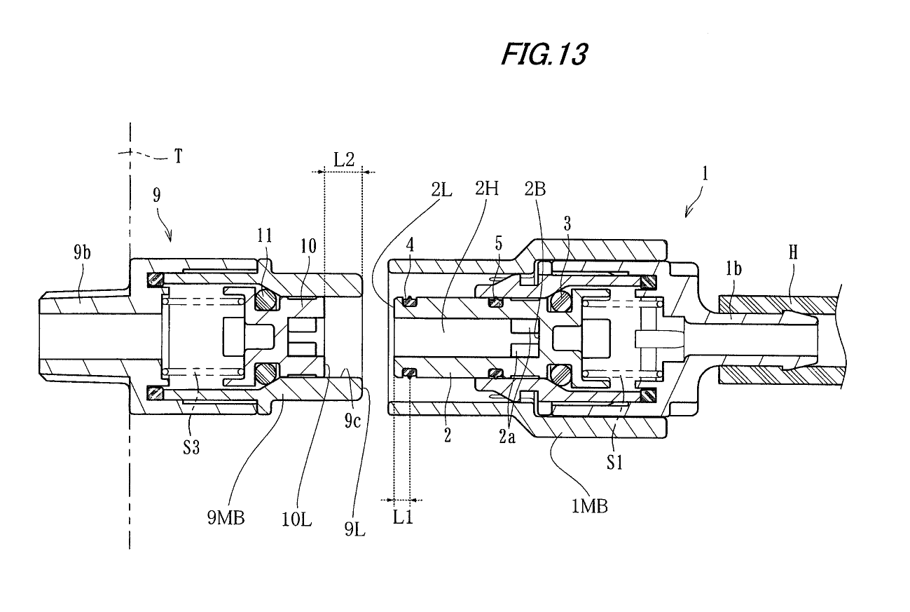

Another first connector 1 having the same configuration as described above is formed at the other end of the fuel tube H and another second connector 9 that is connectable to the first connector 1 is attached to the fuel tank T containing the fuel. The second connector 9 is formed at the fuel outlet Ta of the fuel tank T and includes a pair of recesses 9a, a screw portion 9b that is fixed to the fuel outlet Ta of the fuel tank T by a screw, an insertion portion 9c into which the valve member 2 of the first connector 1 is inserted, a valve member 10, and a second sealing member 11, as shown in FIGS. 11 and 12. Among these, the recesses 9a are engaged with the engaging portions 1a when the first connector 1 is connected to the second connector 9, thereby locking the coupling state.

The valve member 10 is received in the second connector 9 and is slidable in an axis direction (in a horizontal direction of FIG. 12), and includes the second sealing member 11 that closes and seals the fuel outlet Ta of the fuel tank T. The valve member 10 is always urged by a spring S3 in a direction of pressing the second sealing member 11 to a wall surface (in a rightward direction in FIG. 12), and sealing is achieved by the second sealing member 11 under such a urging force and a channel at the fuel outlet Ta is closed and sealed. The second sealing member 11 may be an O-ring that can seal a channel of fuel.

The valve member 10 includes a second communication hole 10a that communicates with an inside and an outside thereof, and allows the fuel to flow to the fuel tube H through the second communication hole 10a when the sealing by the second sealing member 11 is released (specifically, when the sealing is released by connecting the first connector 1 and the second connector 9 to each other). Although the second sealing member 9 is fixed to the fuel outlet Ta by the screw portion 9b in the present embodiment, the second sealing member 9 may be fixed to the fuel outlet Ta of the fuel tank T in any other fixing method such as press-fitting.

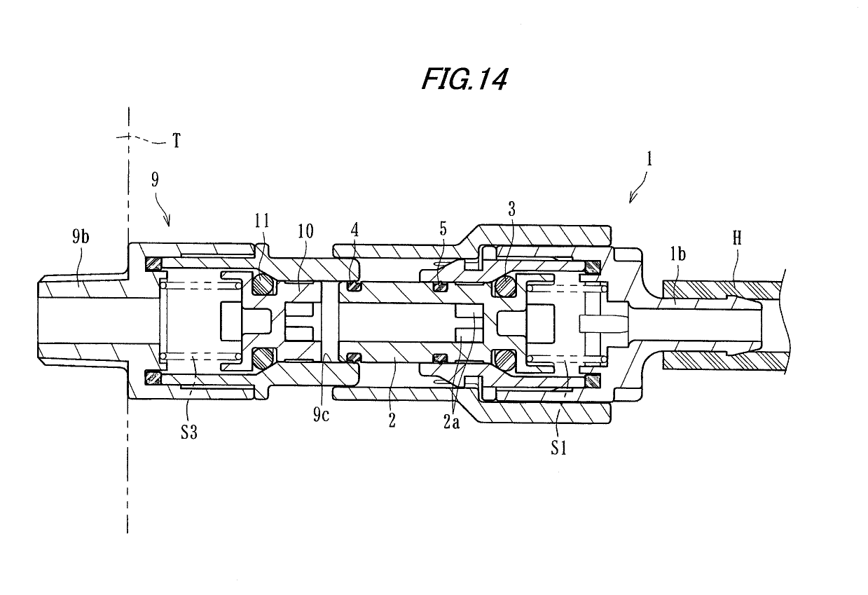

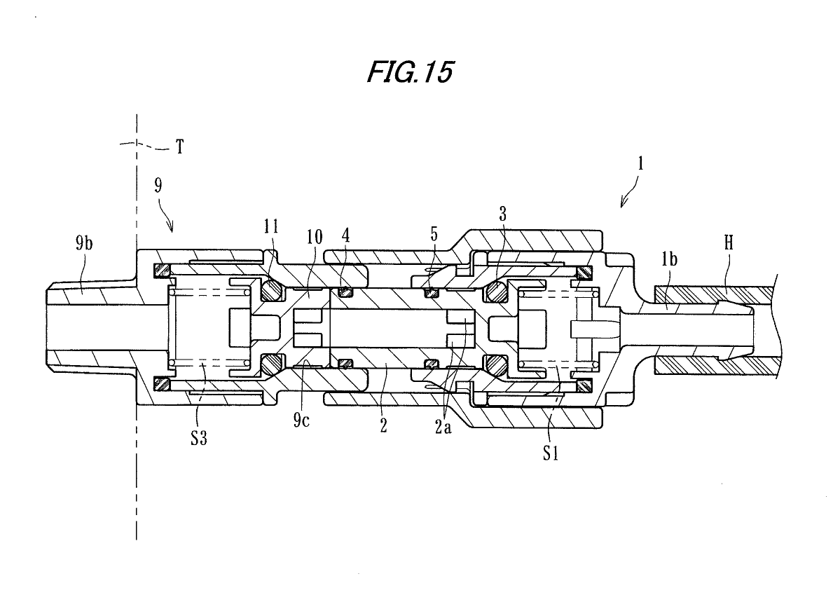

Hereinafter, an operation in the process of connecting the first connector 1 and the second connector 9 to each other will be explained. After the end of the fuel tube H (the opposite end of the end connected to the outboard motor K) is extended to the fuel tank T, the first connector 1 approaches the second connector 9 opposite to the second connector 9 as shown in FIG. 13. If the approaching operation continues after the end of the valve member 2 of the first connector 1 is inserted into the insertion portion 9c of the second connector 9 as shown in FIG. 14, the end of the valve member 2 contacts an end of the valve member 10 of the second connector 9 as shown in FIG. 15.

In this state, the first sealing member 3 of the first connector 1 maintains the sealing and the fuel-tube-side-sealing-member 5 forms a sealed space by sealing the space including the first communication hole 2a with the first sealing member 3. Likewise, the second sealing member 11 of the second connector 9 maintains sealing and the non-fuel-tube-side-sealing-member 4 forms a sealed space by sealing a space is including the second communication hole 10a with the second sealing member 11.

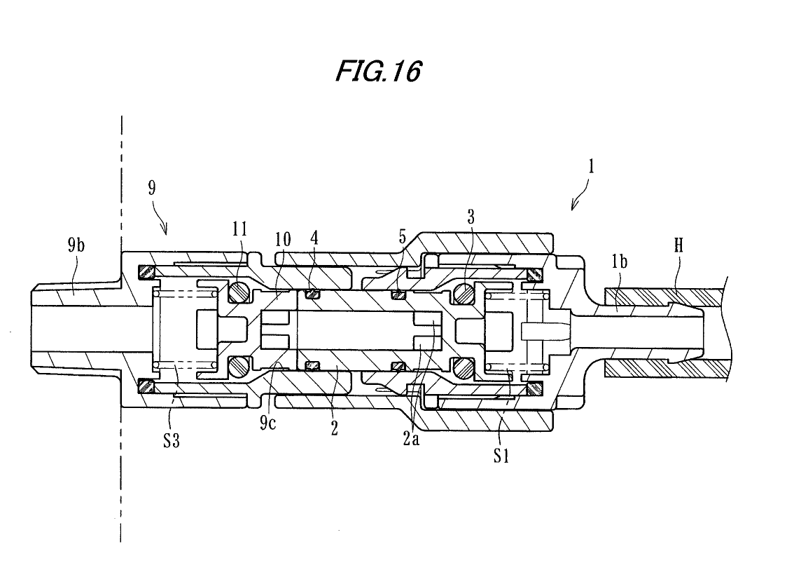

After that, if the approaching operation further continues, the valve member 2 is moved against the urging force of the spring S1 and the first sealing member 3 is separated from the wall surface so that the sealing by the first sealing member 3 is released, and, the valve member 10 is moved against the urging force of the spring S3 and the second sealing member 11 is separated from the wall surface so that the sealing by the second sealing member 11 is released, as shown in FIG. 16. After sealing is achieved by the third sealing member (the fuel-tube-side-sealing-member 5 and the non-fuel-tube-side-sealing-member 4), the sealing by the first sealing member 3 and the sealing by the second sealing member 11 are released.

That is, after the sealing is achieved by the fuel-tube-side-sealing-member 5 and the non-fuel-tube-side-sealing-member 4, the sealing by the first sealing member 3 and the sealing by the second sealing member 11 are simultaneously released. Accordingly, the fuel in the fuel tank T reaches the fuel tube H through the second communication hole 10a of the second connector 9 and the first communication hole 2a of the first connector 1, and is supplied to the outboard motor K through the fuel tube H.

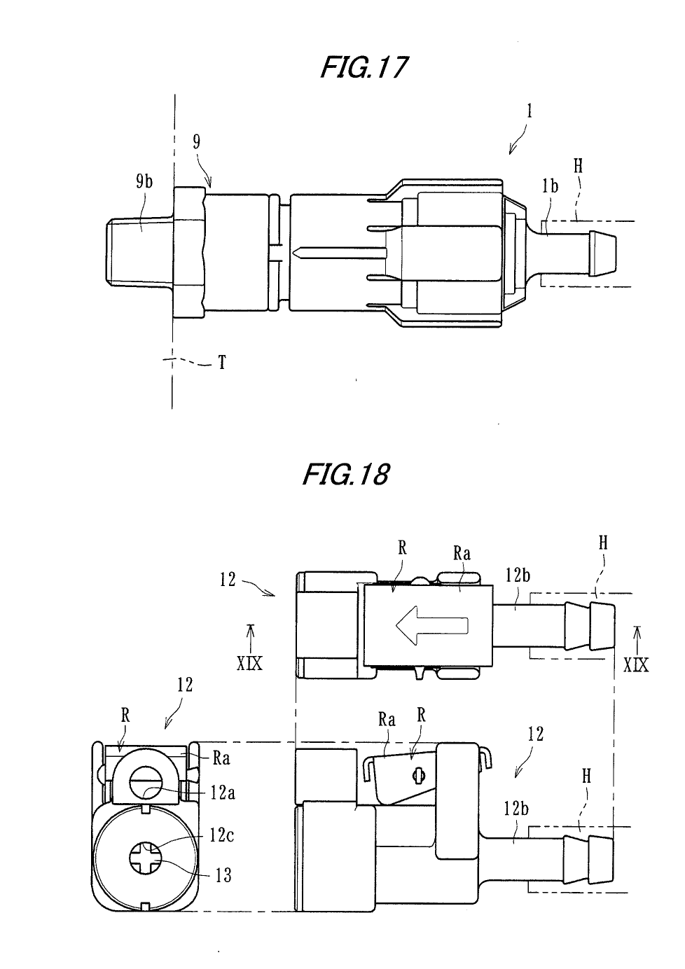

According to the embodiment, in the process of connecting the first connector 1 and the second connector 9 to each other, the engaging portions I a are fitted into the recesses 9a and slide along the recesses 9a. After the connection, locking is achieved by rotating the first connector 1 on the second connector 9 (see FIG. 17). That is, the engaging portions 1a and the recesses 9a configure a locking mechanism that locks the coupling state between the first connector 1 and the second connector 9, and also, the locking is achieved by rotating the first connector 1 on the second connector 9.

In order to release the connection and disconnect the first connector 1 and the second connector 9 from each other, the locking by the engaging portions 1a and the recesses 9a (locking mechanism) is released by rotating the first connector 1 on the second connector 9 in an opposite direction to that of the locking. After the sealing is achieved by the first sealing member 3 and the second sealing member 11 and the sealed space is formed with the third sealing member (the fuel-tube-side-sealing-member 5 and the non-fuel-tube-side-sealing-member 4) by separating the first connector 1 from the second connector 9, the first connector 1 and the second connector 9 are disconnected from each other.

Specifically, in the process of disconnecting the first connector 1 and the second connector 9 from each other, the valve member 2 and the valve member 10 are moved in an opposite direction to that of the connection, and the first sealing member 3 and the second sealing member 11 contact the sidewall, thereby achieving the sealing. After the sealing by the first sealing member 3 and the sealing by the second sealing member 11 are achieved simultaneously and the sealed spaces are formed with the fuel-tube-side-sealing-member 5 and the non-fuel-tube-side-sealing-member 4 simultaneously, the first connector 1 and the second connector 9 are disconnected from each other.

According to the first embodiment described above, the third sealing member (the fuel-tube-side-sealing-member 5 and the non-fuel-tube-side-sealing-member 4) is provided to form the sealed space by sealing the space including the communication hole 2a, 7a, 10a with the first sealing member 3 or the second sealing member 8, 11 in the state in which the sealing by the first sealing member 3 or the second sealing member 8, 11 (the first sealing member 3 and the second sealing member 8, 11 in the present embodiment) is maintained in the process of connecting the first connector 1 and the second connector 6, 9 to each other. Since the sealing by the first sealing member 3 and the sealing by the second sealing member 8, 11 are released after the sealing is achieved by the third sealing member, the fuel can be prevented from spurting when the first connector 1 and the second connector 6, 9 are coupled to each other.

In particular, the first communication hole 2a is formed in the first connector 1 and the second communication hole 7a, 10a is formed in the second connector 6, 9, and also, the fuel-tube-side-sealing-member 5 is provided to form the sealed space by sealing the space including the first communication hole 2a with the first sealing member 3 and the non-fuel-tube-side-sealing-member 4 is provided to form the sealed space by sealing the space including the second communication hole 7a, 10a with the second sealing member 8, 11. Therefore, the present invention can be easily applied to a coupler in which the communication hole is formed in both the first connector 1 and the second connector 6, 9.

Since the sealing by the first sealing member 3 and the sealing by the second sealing member 8, 11 are simultaneously released after the sealing is achieved by the fuel-tube-side-sealing-member 5 and the non-fuel-tube-side-sealing-member 4, the present invention can be easily applied to a coupler in which the communication hole is formed in both the first connector 1 and the second connector 6, 9. Also, comparing a method of releasing the sealing by the first sealing member 1 and the sealing by the second sealing member 8, 11 in sequence, the above-described method can avoid an excessive load being imposed on one of the first sealing member 3 and the second sealing member 8, 11 when the first connector 1 and the second connector 6, 9 are coupled to each other.

The third sealing member (the fuel-tube-side-sealing-member 5 and the non-fuel-tube-side-sealing-member 4) is provided to form the sealed space by sealing the space including the communication hole 2a, 7a, 10a with the first sealing member 3 or the second sealing member 8, 11 in the state in which the sealing is achieved by the first sealing member 3 or the second sealing member 8, 11 in the process of disconnecting the first connector 1 and the second connector 6, 9 from each other. Also, since the first connector 1 and the second connector 6, 9 are disconnected from each other after the sealing is achieved by the first sealing member 3 and the second sealing member 8, 11 and the sealed space is formed with the third sealing member (the fuel-tube-side-sealing-member 5 and the non-fuel-tube-side-sealing-member 4), the fuel can be prevented from spurting when the first connector 1 and the second connector 6, 9 are disconnected from each other.

Since the first connector 1 and the second connector 6, 9 are disconnected from each other after the sealing by the first sealing member 3 and the sealing by the second sealing member 8, 11 are simultaneously achieved and the sealed spaces are simultaneously formed with the fuel-tube-side-sealing-member 5 and the non-fuel-tube-side-sealing-member 4, the present invention can be easily applied to a coupler in which the communication hole 2a, 7a, 10a is formed in both the first connector 1 and the second connector 6, 9, and also, an excessive load can be prevented from being imposed on one of the first sealing member 3 and the second sealing member 8, 11 when the first connector 1 and the second connector 6, 9 are disconnected from each other.

The locking mechanism is provided to lock the coupling state between the first connector 1 and the second connector 6, 9, and the locking is achieved by rotating the first connector 1 on the second connector 6, 9. Therefore, the locking operation can be performed easily and exactly. Although the engaging portions 1a formed on the first connector 1 are engaged with the recesses 6a, 9a formed on the second connector 6, 9 in the present embodiment, any other locking mechanism may be used. For example, engaging portions formed on the second connector 6, 9 may be engaged with recesses formed on the first connector 1.

Hereinafter, a second embodiment will be explained. Similar to the coupler of the first embodiment, a coupler according to the second embodiment connects an end of a fuel tube H to a fuel inlet Ka of an outboard motor K or a fuel outlet Ta of a fuel tank T. As shown in FIGS. 18 to 21, the coupler includes a first connector 12, a second connector 16 that is attached to the fuel inlet Ka of the outboard motor K, and another second connector 9 that is attached to the fuel outlet Ta of the fuel tank T.

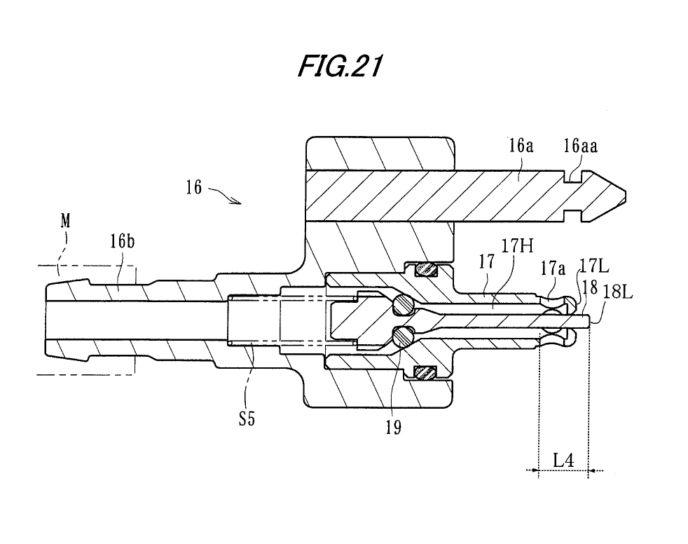

The first connector 12 is formed at one end of the fuel tube H, and includes an insertion penetrating hole 12a, a connection portion 12b to which the fuel tube H is connected, a valve member 13, a first sealing member 14, a third sealing member 15, and an insertion hole 12c into which a protrusion 17 of the second connector 16 (see FIG. 21) is inserted. Among these, the insertion penetrating hole 12a is a hole that allows a locked member 16a of the second connector 16 (see FIG. 21) to be penetratingly inserted, and allows the locked member 16a, which is locked into a locking mechanism R, to be penetratingly inserted. The locking mechanism R includes a locking member Ra that is engaged with an engaging recess 16a a of the locked member 16a, and a spring Rb that urges the locking member Ra toward a locking position.

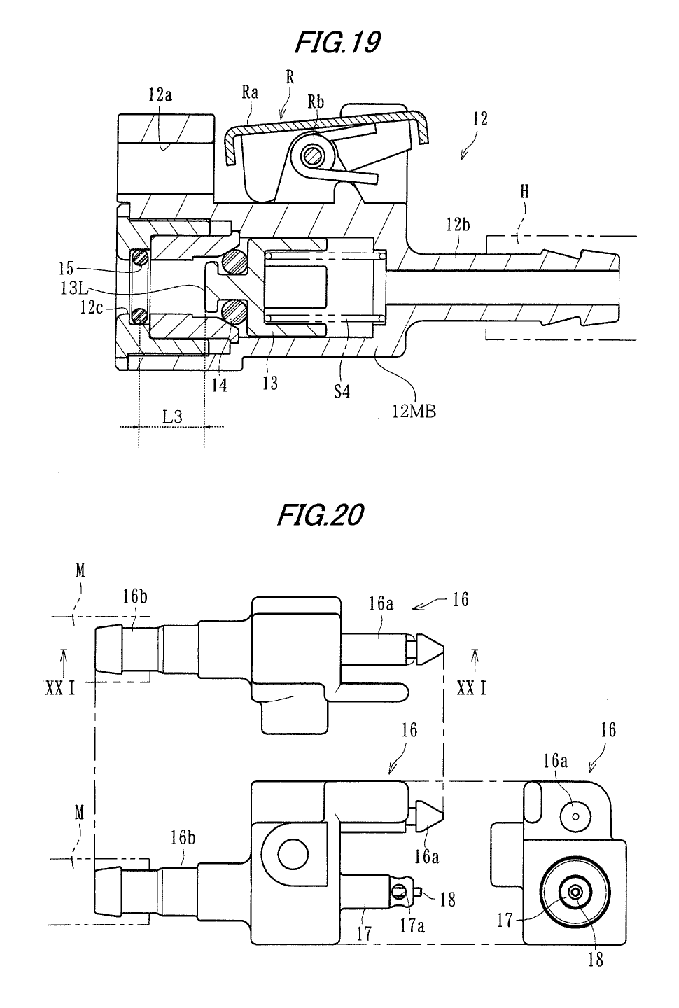

The valve member 13 is received in the first connector 12 and is slidable in an axis direction (in a horizontal direction of FIG. 19), and includes the first sealing member 14 that closes and seals the end of the fuel tube H. The valve member 13 is always urged by a spring S4 in a direction of pressing the first sealing member 14 to a wall surface (in a leftward direction in FIG. 19), and sealing is achieved by the first sealing member 14 under such a urging force and a channel at the end of the fuel tube H is closed and sealed. The first sealing member 14 may be an O-ring that can seal a channel of fuel.

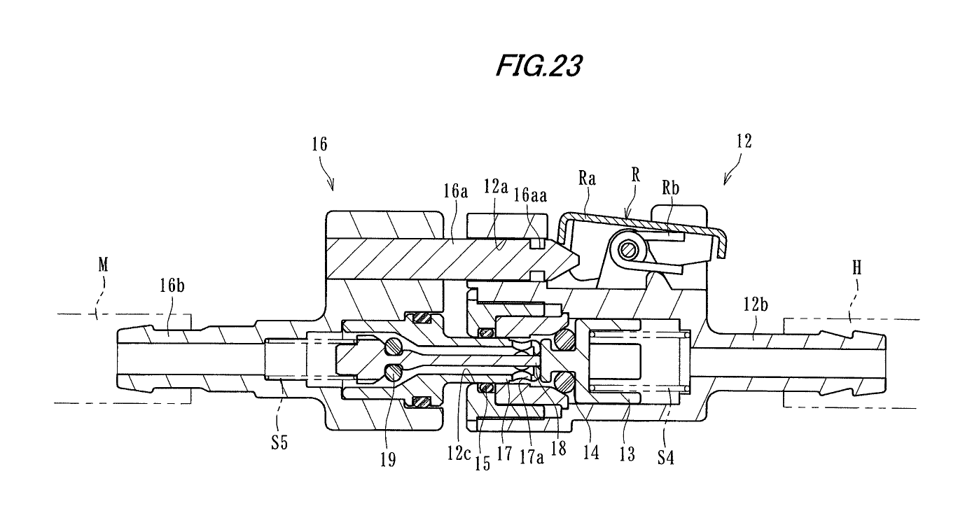

The third sealing member 15 is formed on a predetermined position of the insertion hole 12c (a position between the insertion hole 12c and the first sealing member 14), and contacts an outer circumference of the protrusion 17 inserted into the insertion hole 12c and seals between the outer circumference and an inner circumference of the insertion hole 12c. However, the third sealing member 15 may form a sealed space by sealing a space including a communication hole 17a with the first sealing member 14 in a state in which the sealing by the first sealing member 14 is maintained in the process of connecting the first connector 12 and the second connector 16 to each other, as shown in FIG. 23.

The second connector 16 is formed at the fuel inlet Ka of the outboard motor K and is connectable to the first connector 12, and includes the locked member 16a, a connection portion 16b that is connected to a fuel tube M extending to an engine (not shown) of the outboard motor K, the protrusion 17 that is inserted into the insertion hole 12c of the first connector 12, a pressing member 18 of a shaft shape, and a second sealing member 19, as shown in FIGS. 20 and 21. Among these, the locked member 16a has the engaging recess 16a a formed on an end portion thereof and is shaped in a bar to be penetratingly inserted into the insertion penetrating hole 12a of the first connector 12.

The protrusion 17 includes a plurality of communication holes 17a formed on an end portion thereof and allowing the fuel to flow when the first connector 12 and the second connector 16 are coupled to each other, and receives the pressing member 18 therein. The pressing member 18 is moved in a lengthwise direction (in a horizontal direction of FIG. 21) in the process of connecting the first connector 12 and the second connector 16 to each other, thereby releasing the sealing by the first sealing member 14 and the second sealing member 19.

More specifically, the pressing member 18 includes the second sealing member 19 that closes and seals the fuel inlet Ka of the outboard motor K. The pressing member 18 is always urged by a spring S5 in a direction of pressing the second sealing member 19 to a wall surface (in a rightward direction in FIG. 21), and sealing is achieved by the second sealing member 19 under such a urging force and a channel at the fuel inlet Ka is closed and sealed. The second sealing member 19 may be an O-ring that seals a channel of fuel.

If the pressing member 18 presses the valve member 13 in the same direction and moves the valve member 13 against the urging force of the spring S4 when the first connector 12 and the second connector 16 are coupled to each other, the first sealing member 14 is separated from the wall surface and the sealing is released. Also, if the pressing member 18 is moved against the urging force of the spring S5 (in the leftward direction in FIG. 21), the second sealing member 19 is separated from the wall surface and the sealing is released.

Hereinafter, an operation in the process of connecting the first connector 12 and the second connector 16 to each other will be explained.

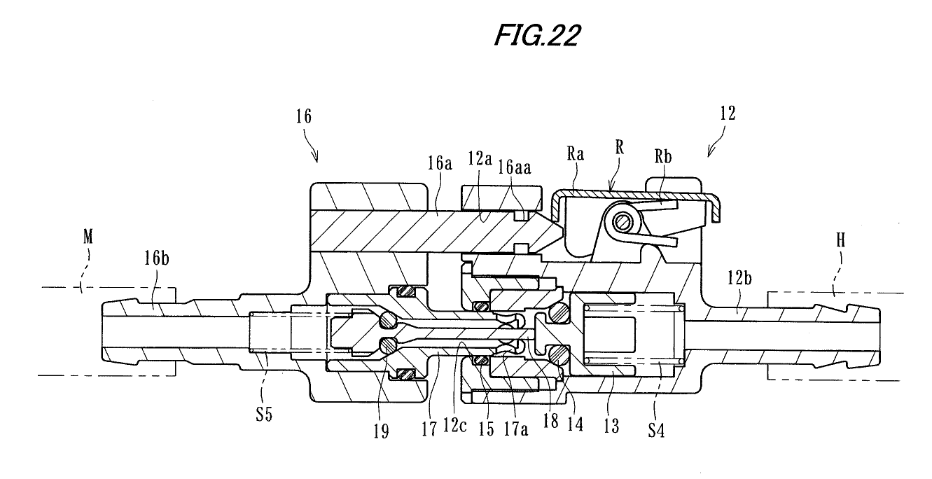

After the end of the fuel tube H is extended to the outboard motor K, the locked member 16a is penetratingly inserted into the insertion penetrating hole 12a, the protrusion 17 is inserted into the insertion hole 12c of the first connector 12, and the end of the pressing member 18 is placed in contact with the valve member 13, as shown in FIG. 22. At this time, the sealing by the first sealing member 14 of the first connector 12 and the sealing by the second sealing member 19 of the second connector 16 are maintained, and, the third sealing member 15 forms the sealed space by sealing the space including the communication hole 17a with the first sealing member 14.

If the first connector 12 further approaches the second connector 16, the pressing member 18 is urged by the valve member 13 and is moved in the leftward direction in the drawing against the urging force of the spring S5 as shown in FIG. 23. Consequently, the second sealing member 19 is separated from the wall surface so that the sealing by the second sealing member 19 is released. That is, the urging force of the spring S4 is set to be greater than the urging force of the spring S5, and the pressing member 18 is moved against the urging force of the spring S5 first. On the other hand, the locked member 16a further advances and rocks the locking member Ra against an urging force of the spring Rb.

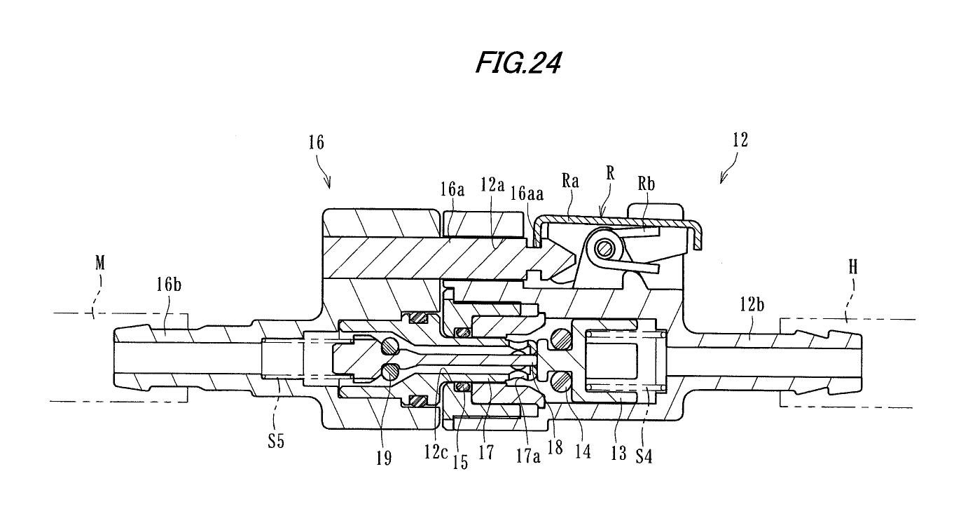

After that, if the approaching operation further continues, the pressing member 18 is urged by the valve member 13 and is moved in the rightward direction in the drawing against the urging force of the spring S4 as shown in FIG. 24. Consequently, the first sealing member 14 is separated from the wall surface so that the sealing by the first sealing member 14 is released. After sealing is achieved by the third sealing member 15, the sealing by the first sealing member 14 is released.

That is, after the sealing is achieved by the third sealing member 15, the sealing by the second sealing member 19 is released first and then the sealing by the first sealing member 14 is released. Consequently, the fuel flowing through the fuel tube H reaches the fuel tube M through the first connector 12, the communication hole 17a, and the second connector 16, and is supplied to the engine of the outboard motor K through the fuel tube M.

Since the locking member Ra of the locking mechanism R is engaged with the engaging recess 16a a of the locked member 16a in the coupling state, the coupling state between the first connector 12 and the second connector 16 is locked by the locking mechanism R. Instead of using such a locking mechanism, the locking may be achieved by rotating the first connector 12 on the second connector 16 as in the first embodiment. However, although the above-described second connector 16 is attached to the fuel inlet Ka of the outboard motor K, the second connector 9 attached to the fuel outlet Ta of the fuel tank T has the same configuration.

In order to release the connection and disconnect the first connector 12 and the second connector 16 from each other, the locking is released by releasing the engagement of the locking member Ra with the engaging recess 16a a of the locked member 16a by rocking the locking member Ra. After the sealing is achieved by the first sealing member 14 and the sealed space is formed with the third sealing member 15 by separating the first connector. 12 from the second connector 16, the first connector 12 and the second connector 16 are disconnected. Specifically, in the process of disconnecting the first connector 12 and the second connector 16 from each other, the pressing member 18 is moved in the lengthwise direction (in the leftward direction in FIG. 24), and, after the sealing is achieved by the first sealing member 14 and the sealed space is formed with the third sealing member 15 as shown in FIG. 23, the first connector 12 and the second connector 16 are disconnected from each other.

According to the second embodiment, the third sealing member 15 is provided to form the sealed space by sealing the space including the communication hole 17a with the first sealing member 14 in the state in which the sealing by the first sealing member 14 or the second sealing member 19 (the first sealing member 14 and the second sealing member 19 in the present embodiment) is maintained in the process of connecting the first connector 12 and the second connector 16 to each other. Since the sealing by the first sealing member 14 and the second sealing member 19 is released after the sealing is achieved by the third sealing member 15, the fuel can be prevented from spurting when the first connector 12 and the second connector 16 are coupled to each other.

In particular, the pressing member 18 of the shaft shape is provided to release the sealing by the first sealing member 14 and the second sealing member 19 by being moved in the lengthwise direction in the process of connecting the first connector 12 and the second connector 16 to each other. Since the pressing member 18 is moved and releases the sealing by the first sealing member 14 after the sealing is achieved by the third sealing member 15, the present invention can be easily applied to a coupler for an existing fuel tube that includes the pressing member 18.

The third sealing member 15 is provided to form the sealed space by sealing the space including the communication hole 17a with the first sealing member 14 or the second sealing member 19 in the state in which the sealing is achieved by the first sealing member 14 or the second sealing member 19 in the process of disconnecting the first connector 12 and the second connector 16 from each other. Since the first connector 12 and the second connector 16 are disconnected from each other after the sealing is achieved by the first sealing member 14 and the second sealing member 19 and the sealed space is formed with the third sealing member 15, the fuel can be prevented from spurting when the first connector 12 and the second connector 16 are disconnected from each other.

The pressing member 18 of the shaft shape is provided to seal by the first sealing member 14 and the second sealing member 19 by being moved in the lengthwise direction in the process of disconnecting the first connector 12 and the second connector 16 from each other. Since the first connector 12 and the second connector 16 are disconnected from each other after sealing is achieved by the first sealing member 14 or the second sealing member 19 by the pressing member 18 being moved and the sealed space is formed with the third sealing member 15, the present invention can be easily applied to a coupler for an existing fuel tube that includes the pressing member 18.

Although the embodiments have been described, the present invention should not be considered as limiting. For example, the locking mechanism that locks the coupling state between the first connector and the second connector may have other forms, and the configurations of the first connector and the second connector may be reversed. Although the first connector are formed at one end of the fuel tube H and the other end of the fuel tube H in the present embodiments, the first connector may be formed only at one of the ends.

Although the outboard motor of the small ship communicates with the fuel tank through the fuel tube in the present embodiments, the present invention can be applied to a coupler that supplies fuel to a driving source of any other boarding means instead of the small ship (vehicle other than the ship) or can be applied to a coupler that supplies fuel to a driving source other than the boarding means (for example, an electric generator). The fuel used may be gas other than liquid, such as LPG.

According to an embodiment, an apparatus of a different appearance or an apparatus to which a different function may be added, provided that the apparatus satisfies conditions (i) and (ii) as follows:

(i) The coupler has the third sealing member that forms the sealed space by sealing the space including the communication hole with the first sealing member or the second sealing member in the state the sealing by the first sealing member or the o second sealing member is maintained in the process of connecting or disconnecting the first connector and the second connector.

(ii) The coupler has a configuration that the sealing by the first sealing member and the second sealing member is released after the sealing is achieved by the third sealing member, or has a configuration that the first connector and the second connector are disconnected from each other after the sealing is achieved by the first sealing member and the second sealing member and the sealed space is formed with the third sealing member.

In accordance with the embodiments described in the above (for example, the embodiment as shown in FIG. 6 or 13), a coupler may include: a first connector 1 including a base end 1b to be connected to one H of an upstream and a downstream of a fuel-feeding-line; and a second connector 6, 9 including a base end 6b, 9b to be connected to the other K, T of the upstream and the downstream of the fuel-feeding-line. The first connector 1 may include: a first-connector-main-body 1MB; a first-connector-valve-member 2 disposed in the first-connector-main-body 1MB and slidable in an axial direction; a first-connector-spring S1 configured to urge the first-connector-valve-member 2 toward a leading end side of the first connector 1 with respect to the first-connector-main-body 1MB; a first-connector-base-end-seal 3 arranged between the first-connector-main-body 1MB and the first-connector-valve-member 2; a first-connector-leading-end-seal 4 provided on a leading end side of the first-connector-valve-member 2; a first-connector-intermediate-seal 5 arranged between the first-connector-main-body 1MB and the first-connector-valve-member 2 in an axial position between the first-connector-base-end-seal 3 and the first-connector-leading-end-seal 4. The first-connector-valve-member 2 may be formed with a valve-member-blind-path 2H extending from a leading end 2L of the first-connector-valve-member 2 to a bottom 2B and an opening 2a penetrating from an outer circumference to the valve-member-blind-path H in an axial position between first-connector-base-end-seal 3 and the first-connector-intermediate-seal 5. The second connector 6, 9 may include: a second-connector-main-body 6MB, 9MB; a second-connector-valve-member 7, 10 disposed in the second-connector-main-body 6MB, 9MB and slidable in an axial direction; a second-connector-spring S2, S3 configured to urge the second-connector-valve-member 7, 10 toward a leading end side of the second connector 6, 9 with respect to the second-connector-main-body 6MB, 9MB; and a second-connector-seal 8, 11 arranged between the second-connector-main-body 6MB, 9MB and the second-connector-valve-member 7, 10. An insertion portion 6c, 9c may be formed on a leading end 6L, 9L of the second connector main body 6MB, 9MB. A leading end 7L, 10L of the second-connector-valve-member 7, 10 may be slidable in the insertion portion 6c, 9c. In a condition in which the first connector 1 and the second connector 6, 9 are coupled with each other, a leading end 2L of the first-connector-valve-member 2 may position within the insertion portion 6c, 9c of the second connector-main-body 6MB, 9MB, a seal between an outer circumference of the leading end 2L of the first-connector-valve-member 2 and an inner circumference of insertion portion 6c, 9c of the second connector main body 6MB, 9MB may be formed by the first-connector-leading-end-seal 4, and the leading end 2L of the first-connector-valve-member 2 and the leading end 7L, 10L of the second-connector-valve-member 7, 10 may be in contact and press to each other toward respective base end sides. An axial length L2 from the leading end 6L, 9L of the second connector main body 6MB, 9MB to the leading end 7L, 10L of the second-connector-valve-member 7, 10 in a condition in which the first connector 1 and the second connector 6, 9 are disconnected to each other may be larger than an axial length L1 from the leading end 2L of the first-connector-valve-member 2 to the first-connector-leading-end-seal 4.

Moreover, in accordance with the embodiments described in the above (for example, the embodiment as shown in FIGS. 19 and 21), a coupler may include: a first connector 12 including a base end 12b to be connected to one H of an upstream and a downstream of a fuel-feeding-line; and a second connector 16 including a base end 16b to be connected to the other K, T of the upstream and the downstream of the fuel-feeding-line. The first connector 12 may include: a first-connector-main-body 12MB; a first-connector-valve-member 13 disposed in the first-connector-main-body 1MB and slidable in an axial direction; a first-connector-spring S4 configured to urge the first-connector-valve-member 13 toward a leading end side of the first connector 12 with respect to the first-connector-main-body 12MB; a first-connector-base-end-seal 14 arranged between the first-connector-main-body 12MB and the first-connector-valve-member 13; an insertion hole 12c formed on an leading end 12L of the first-connector-main-body 12MB; and a first-connector-leading-end-seal 15 provided on an inner circumference of the insertion hole 12c. A leading end 13L of the first-connector-valve-member 13 may be slidable in the insertion hole 12c. The second connector 16 may include: a second-connector-main-body 16MB; a second-connector-valve-member 18 disposed in the second-connector-main-body 16MB and slidable in an axial direction; a second-connector-spring S5 configured to urge the second-connector-valve-member 18 toward a leading end side of the second connector 16 with respect to the second-connector-main-body 16MB; a second-connector-seal 19 arranged between the second-connector-main-body 16MB and the second-connector-valve-member 18; and a protrusion 17 protruding from the second-connector-main-body 16MB toward the leading end side of the second connector 16. A path 17H may be formed in an inside of the protrusion 17. An opening 17a penetrating from an outer circumference of the protrusion to the path 17H may be formed. A part of the second-connector-valve-member 18 may be accommodated in the path 17H. A leading end 18L of the second-connector-valve-member 18 may further protrude beyond a leading end 17L of the protrusion 17 toward the leading end side of the second connector 16. In a condition in which the first connector 1 and the second connector 6, 9 are coupled with each other, the leading end 17 of the protrusion 17 and the leading end 18L of the second-connector-valve-member 18 may position in the insertion hole 12c of the first-connector-main-body 12MB, a seal between an outer circumference of a part of the protrusion 17 at a base end side of the opening 17a and the inner circumference of the insertion hole 12c of the first-connector-main-body 12MB may be formed by the first-connector-leading-end-seal 15, and the leading end 13L of the first-connector-valve-member 13 and the leading end 18L of the second-connector-valve-member 18 may be in contact and press to each other toward respective base end sides. An axial length L3 from the leading end 12L of the first-connector-main-body 12MB to the leading end 13L of the first-connector-valve-member 13 in a condition in which the first connector 1 and the second connector 6, 9 are disconnected to each other may be larger than an axial length L4 from the leading end 18L of the second-connector-valve-member 18 to the opening 17a in the condition in which the first connector 1 and the second connector 6, 9 are disconnected to each other.

What is claimed is:

1. A coupler comprising:
a first connector to be connected to an end of the fuel tube;
a first sealing member provided in the first connector and configured to close and seal an end of the fuel tube;
a second connector to be connected to a fuel inlet of a driving source to which fuel is supplied or a fuel outlet of a fuel tank,
a second sealing member provided in the second connector and configured to close and seal said fuel inlet or said fuel outlet; and
a communication hole through which the fuel flows when the first connector and the second connector are coupled with each other,
wherein a sealing by the first sealing member and the second sealing member is released when the first connector and the second connector are coupled with each other so as to allow the fuel to flow,
wherein the coupler further comprises a third sealing member configured to form a sealed space by sealing a space including the communication hole with the first sealing member or the second sealing member in a state in which the sealing by the first sealing member or the second sealing member is maintained in a process of coupling the first sealing member and the second sealing member with each other, and
wherein the sealing by the first sealing member and the second sealing member is released after a sealing by the third sealing member is achieved.

2. The coupler according to claim 1, wherein the communication hole comprises a first communication hole that is formed in the first connector and a second communication hole that is formed in the second connector,
wherein the third sealing member comprises a fuel-tube-side-sealing-member that forms a sealed space by sealing a space including the first communication hole with the first sealing member and a non-fuel-tube-side-sealing-member that forms a sealed space by sealing a space including the second communication hole with the second sealing member.

3. The coupler according to claim 2, wherein the sealing by the first sealing member and the sealing by the second sealing member are simultaneously released after a sealing by the fuel-tube-side-sealing-member and the non-fuel-tube-side-sealing-member is achieved.

4. The coupler according to claim 1, further comprising:
a pressing member of a shaft shape configured to move in a lengthwise direction in the process of coupling the first connector and the second connector to each other so as to release the sealing by the first sealing member and the second is sealing member,
wherein the pressing member is configured to move and release the sealing by the first sealing member or the second sealing member after the sealing by the third sealing member is achieved.

5. A coupler comprising:
a first connector to be connected to an end of the fuel tube;
a first sealing member provided in the first connector and configured to close and seal an end of the fuel tube;
a second connector to be connected to a fuel inlet of a driving source to which fuel is supplied or a fuel outlet of a fuel tank,
a second sealing member provided in the second connector and configured to close and seal said fuel inlet or said fuel outlet; and
a communication hole through which the fuel flows when the first connector and the second connector are coupled with each other,
wherein a sealing by the first sealing member and the second sealing member is released when the first connector and the second connector are coupled with each other so as to allow the fuel to flow,
wherein the coupler further comprises a third sealing member configured to form a sealed space by sealing a space including the communication hole with the first sealing member or the second sealing member in a state in which the sealing by the o first sealing member or the second sealing member is achieved in a process of disconnecting the first connector and the second connector from each other, and
wherein the first connector and the second connector are disconnected from each other after the sealing by the first sealing member and the second sealing member is achieved and the sealed space is formed by the third sealing member.

6. The coupler according to claim 5, wherein the communication hole comprises a first communication hole that is formed in the first connector and a second communication hole that is formed in the second connector,
wherein the third sealing member comprises a fuel-tube-side-sealing-member that forms a sealed space by sealing a space including the first communication hole with the first sealing member, and a non-fuel-tube-side-sealing-member that forms a sealed space by sealing a space including the second communication hole with the second sealing member.

7. The coupler according to claim 6, wherein the first connector and the second connector are disconnected from each other after the sealing by the first sealing member and the sealing by the second sealing member are achieved simultaneously and the sealed spaces by the fuel-tube-side-sealing-member and the non-fuel-tube-side-sealing-member are simultaneously formed.

8. The coupler according to claim 5, further comprising
a pressing member of a shaft shape configured to move in a lengthwise direction in the process of disconnecting the first connector and the second connector from each other and to achieve the sealing by the first sealing member and the second sealing member,
wherein the first connector and the second connector are disconnected from each other after the sealing by the first sealing member or the second sealing member is achieved by moving the pressing member and the sealed space is formed by the third sealing member.

9. The coupler according to claim 1, further comprising:
a locking mechanism configured to lock a coupling state between the first connector and the second connector by rotating the first connector with respect to the second connector.

10. A coupler comprising:
a first connector (1) including a base end (1b) to be connected to one (H) of an upstream and a downstream of a fuel-feeding-line; and
a second connector (6, 9) including a base end (6b, 9b) to be connected to the other (K, T) of the upstream and the downstream of the fuel-feeding-line;
wherein the first connector (1) includes:
a first-connector-main-body (1MB);
a first-connector-valve-member (2) disposed in the first-connector-main-body (1MB) and slidable in an axial direction;
a first-connector-spring (S1) configured to urge the first-connector-valve-member (2) toward a leading end side of the first connector (1) with respect to the first-connector-main-body (1MB);
a first-connector-base-end-seal (3) arranged between the first-connector-main-body (1MB) and the first-connector-valve-member (2);
a first-connector-leading-end-seal (4) provided on a leading end side of the first-connector-valve-member(2);
a first-connector-intermediate-seal (5) arranged between the first-connector-main-body (1MB) and the first-connector-valve-member (2) in an axial position between the first-connector-base-end-seal (3) and the first-connector-leading-end-seal (4),
wherein the first-connector-valve-member (2) is formed with a valve-member-blind-path (2H) extending from a leading end (2L) of the first-connector-valve-member (2) to a bottom (2B) and an opening (2a) penetrating from an outer circumference to the valve-member-blind-path (H) in an axial position between first-connector-base-end-seal (3) and the first-connector-intermediate-seal (5),
wherein the second connector (6, 9) includes:
a second-connector-main-body (6MB, 9MB);
a second-connector-valve-member (7, 10) disposed in the second-connector-main-body (6MB, 9MB) and slidable in an axial direction;
a second-connector-spring (S2, S3) configured to urge the second-connector-valve-member (7, 10) toward a leading end side of the second connector (6, 9) with respect to the second-connector-main-body (6MB, 9MB); and
a second-connector-seal (8, 11) arranged between the second-connector-main-body (6MB, 9MB) and the second-connector-valve-member (7, 10),
wherein an insertion portion (6c, 9c) is formed on a leading end (6L, 9L) of the second connector main body (6MB, 9MB), and a leading end (7L, 10L) of the second-connector-valve-member (7, 10) is slidable in the insertion portion (6c, 9c),
wherein, in a condition in which the first connector (1) and the second connector (6, 9) are coupled with each other, a leading end (2L) of the first-connector-valve-member (2) positions within the insertion portion (6c, 9c) of the second connector-main-body (6MB, 9MB) and a seal between an outer circumference of the leading end (2L) of the first-connector-valve-member (2) and an inner circumference of insertion portion (6c, 9c) of the second connector main body (6MB, 9MB) is formed by the first-connector-leading-end-seal (4), and the leading end (2L) of the first-connector-valve-member (2) and the leading end (7L, 10L) of the second-connector-valve-member (7, 10) are in contact and press to each other toward respective base end sides, and
wherein an axial length (L2) from the leading end (6L, 9L) of the second connector main body (6MB, 9MB) to the leading end (7L, 10L) of the second-connector-valve-member (7, 10) in a condition in which the first connector (1) and the second connector (6, 9) are disconnected to each other is larger than an axial length (L1) from the leading end (2L) of the first-connector-valve-member (2) to the first-connector-leading-end-seal (4).

11. A coupler comprising:
a first connector (12) including a base end (12b) to be connected to one (H) of an upstream and a downstream of a fuel-feeding-line; and
a second connector (16) including a base end (16b) to be connected to the other (K, T) of the upstream and the downstream of the fuel-feeding-line;
wherein the first connector (12) includes:
a first-connector-main-body (12MB);
a first-connector-valve-member (13) disposed in the first-connector-main-body (1MB) and slidable in an axial direction;
a first-connector-spring (S4) configured to urge the first-connector-valve-member (13) toward a leading end side of the first connector (12) with respect to the first-connector-main-body (12MB);
a first-connector-base-end-seal (14) arranged between the first-connector-main-body (12MB) and the first-connector-valve-member (13);
an insertion hole (12c) formed on an leading end (12L) of the first-connector-main-body (12MB); and
a first-connector-leading-end-seal (15) provided on an inner circumference of the insertion hole (12c),
wherein a leading end (13L) of the first-connector-valve-member (13) is slidable in the insertion hole (12c),
wherein the second connector (16) includes:
a second-connector-main-body (16MB);
a second-connector-valve-member (18) disposed in the second-connector-main-body (16MB) and slidable in an axial direction;
a second-connector-spring (S5) configured to urge the second-connector-valve-member (18) toward a leading end side of the second connector (16) with respect to the second-connector-main-body (16MB);
a second-connector-seal (19) arranged between the second-connector-main-body (16MB) and the second-connector-valve-member (18); and
a protrusion (17) protruding from the second-connector-main-body (16MB) toward the leading end side of the second connector (16),
wherein a path (17H) is formed in an inside of the protrusion (17), an opening (17a) penetrating from an outer circumference of the protrusion to the path (17H) is s formed, a part of the second-connector-valve-member (18) is accommodated in the path (17H), and a leading end (18L) of the second-connector-valve-member (18) further protrudes beyond a leading end (17L) of the protrusion (17) toward the leading end side of the second connector (16),
wherein, in a condition in which the first connector (1) and the second connector (6, 9) are coupled with each other, the leading end (17) of the protrusion (17) and the leading end (18L) of the second-connector-valve-member (18) position in the insertion hole (12c) of the first-connector-main-body (12MB), a seal between an outer circumference of a part of the protrusion (17) at a base end side of the opening (17a) and the inner circumference of the insertion hole (12c) of the first-connector-main-body (12MB) is formed by the first-connector-leading-end-seal (15), and the leading end (13L) of the first-connector-valve-member (13) and the leading end (18L) of the second-connector-valve-member (18) are in contact and press to each other toward respective base end sides, and
wherein an axial length (L3) from the leading end (12L) of the first-connector-main-body (12MB) to the leading end (13L) of the first-connector-valve-member (13) in a condition in which the first connector (1) and the second connector (6, 9) are disconnected to each other is larger than an axial length (L4) from the leading end (18L) of the second-connector-valve-member (18) to the opening (17a) in the condition in which the first connector (1) and the second connector (6, 9) are disconnected to each other.
